(19) United States
(12) Patent Application Publication
(10) Pub. No.: US 2024/0222690 A1
(43) Pub. Date: Jul. 4, 2024

(54) SOLID STATE BATTERY SEPARATOR

(71) Applicant: United States of America as represented by the Administrator of NASA, Washington, DC (US)

(72) Inventors: Donald A. Dornbusch, Cleveland, OH (US); Rocco P. Viggiano, Cleveland, OH (US); Amjad S. Almansour, Cleveland, OH (US); Yi Lin, Cleveland, OH (US)

(21) Appl. No.: 18/542,107

(22) Filed: Dec. 15, 2023

Related U.S. Application Data
(60) Provisional application No. 63/387,936, filed on Dec. 16, 2022.

(51) Int. Cl. H01M 10/056

(52) U.S. Cl. CPC H01M 10/056; H01M 2300/008; H01M 2300/0082; H01M 2300/0091

(57) ABSTRACT

According to some embodiments described and disclosed herein, a separator may comprise a filler and an inorganic solid electrolyte. The filler may comprise fibers with an aspect ratio (L/D) of at least 100/1. The separator may have a thickness of less than 200 μm. Further embodiments include a process for producing a separator.

### CROSS-REFERENCE TO RELATED APPLICATIONS

This application claims the benefit of U.S. Provisional Patent Application Ser. No. 63/387,936 entitled “Solid-State Electrolyte Composites Utilizing Fillers For Improved Mechanical Performance” filed on Dec. 16, 2022. The entirety of the above-noted application is incorporated by reference herein.

### ORIGIN OF THE INVENTION

The invention described herein was made by employees of the United States Government and may be manufactured and used by or for the Government for Government purposes without the payment of any royalties thereon or therefor.

### TECHNICAL FIELD

Embodiments of the present disclosure relate to solid state batteries, and more specifically, to separators suitable for use in solid state batteries.

### BACKGROUND

Currently, solid-state batteries are not commercially available. However, there is significant interest in solid-state batteries due to the potential for low flammability, high specific energy and reduced sensitivity to dendrite formation. If this potential can be realized, the resulting solid-state batteries could be advantageous in numerous applications including aerospace, space applications, automotive, and consumer electronics.

Present solid state battery separators suffer from brittleness, especially at the reduced thicknesses required to achieve reasonable ionic conductivities.

### BRIEF SUMMARY

Accordingly, solid state battery separators which have improved mechanical properties are desired. Embodiments of the present disclosure meet this need by providing solid state battery separators which comprise a filler, the filler having an aspect ratio (L/D) of at least 100/1. Without being limited by theory, it is believed that the use of the present fillers reduces the brittleness of solid-state battery separators, especially when the separators are relatively thin.

According to some embodiments, a separator may comprise a filler and an inorganic solid electrolyte. The filler may comprise fibers with an aspect ratio (L/D) of at least 100/1. The separator may have a thickness of less than 200 μm

According to some embodiments, a process for producing a separator may comprise combining a binder and an organic solvent; combining a filler and the organic solvent to produce a filler mixture; mixing or sonicating the filler mixture to produce a dispersed filler mixture; combining the dispersed filler mixture with a solid electrolyte powder to produce a solid electrolyte suspension; mixing the solid electrolyte suspension; casting the solid electrolyte suspension into a film; and removing solvent from the film, thereby producing the separator.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. Additionally, the descriptions are meant to be merely illustrative, and are not intended to limit the scope of the claims in any manner.

### DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawing, where like structure is indicated with like reference numerals.

FIG. 1 depicts an exploded view of a solid-state battery.

### DETAILED DESCRIPTION

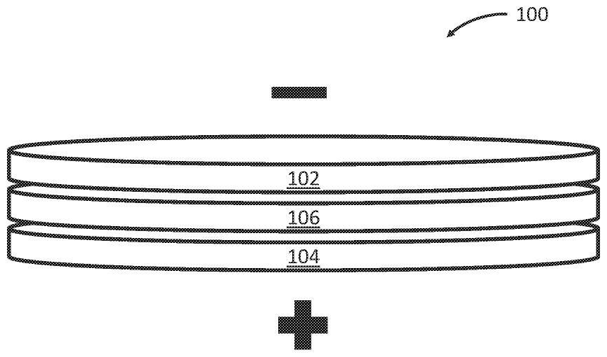

According to an exemplary embodiment of the present disclosure shown in FIG. 1, a solid-state battery 100 comprises an anode 102, a cathode 104, and a separator 106 disposed between the anode 102 and the cathode 104. The anode 102, the cathode 104, and the separator 106 may have a generally planar structure, although in some embodiments the anode 102, the cathode 104, and the separator 106 may each be wrapped in a cylindrical form. Thus, the solid-state battery 100 may take any known form, such as coin cell, a pouch cell, a flat cell, a prismatic cell, or a cylindrical cell. The anode 102 and the cathode 104 of the solid-state battery 100 may each be monopolar or bipolar.

The solid-state battery 100 may be free of solvents and electrolytes, such as aqueous, or ionic liquid solvents or liquid electrolytes. In embodiments, the solid-state battery 100 may comprise less than 1 wt. %, less than 0.5 wt. %, less than 0.1 wt. %, or even less than 0.01 wt. % of liquid solvents or liquid electrolytes.

The anode 102 may comprise lithium. In embodiments, the anode 102 may comprise a layer of elemental lithium metal, a layer of a lithium compound(s), or a layer of doped lithium. An anode current collector may be in electrical contact with the anode. The anode current collector may comprise, as a non-limiting example, a sheet or foil of copper, nickel, a copper-nickel alloy, carbon paper, or graphene paper.

The cathode 104 may comprise a cathode active material. The cathode 104 active material may comprise one or more lithium transition metal oxides and lithium transition metal phosphates which can be bonded together using binders and optionally conductive fillers such as carbon black. Lithium transition metal oxides and lithium transition metal phosphates can include, but are not limited to, LiCoO₂, LiNiO₂, LiNiO_{0.8}Co_{0.15}Al_{0.05}O₂, LiMnO₂, Li(Ni_{0.5}Mn_{0.5})O₂, LiNiₓCo_{y}Mn_{z}O₂, Spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. The cathode active material layer can be a sulfur-based active material and can include LiSO₂, LiSO₂Cl₂, LiSOCl₂, and LiFeS₂, as non-limiting examples.

The separator 106 may function to keep the anode 102 and the cathode 104 from being in electrical contact (which would result in a short). Additionally, the separator 106 may allow the flow of ions. Thus, the separator 106 may be ionically conductive.

The separator 106 may comprise a filler and a solid electrolyte.

The solid electrolyte may comprise an inorganic solid electrolyte. The inorganic solid electrolyte may comprise oxides, sulfides, phosphates, or halides of lithium. The solid electrolyte may have a crystalline, glassy, or ceramic structure.

The inorganic solid electrolyte may comprise lithium phosphorous oxynitride (“LIPON”) materials, lithium superionic conductor like (“LiSiCON”) materials, lithium thiophosphate materials, halide based solid electrolytes, or a combination thereof.

As used herein LiSiCON (which encompasses the term “thio-LiSiCON”) refers to a family of materials having the chemical formulas: Li₂₊₂ₓZn₁₋ₓGeO₄; Li₃₊ₓGeₓV₁₋ₓO₄; Li₄₋ₓSi₁₋ₓPₓO₄; and Li₄₋ₓGe₁₋ₓPₓS₄.

LIPON refers to a family of materials having general formula LiₓPO_{y}N_{z}. Lithium thiophosphate refers to a family of materials including (Li₂S)ₓ(P₂S₅)₁₋ₓ. Halide based solid electrolytes refers to a family of materials comprising lithium and halides.

The inorganic solid electrolyte may comprise Argyrodite solid electrolytes. Agryodite solid electrolytes have the general formula Li_{7+x-y}M^{IV}ₓM^{V}₁₋ₓCh_{6-y}X_{y}, where M^{IV}=Si, Ge, or Sn; M^{V}=P or Sb; Ch=O, S, or Se; X=Cl, Br, I, or BH₄; 0≤ x≤1; and 0≤ y≤2. Agryodite solid electrolytes include Li₆PS₅Cl.

Some non-limiting examples of inorganic solid electrolytes include Li₃PS₄, Li₆PS₅Cl, Li₁₀GeP₂S₁₂; Li₃InC₆, Li₃YCl₆, and Li₃YBr₆.

The separator 106 may comprise from 80 wt. % to 99 wt. % of the inorganic solid electrolyte. In embodiments, the separator may comprise from 80 wt. % to 98 wt. %, from 80 wt. % to 95 wt. %, from 80 wt. % to 90 wt. %, from 80 wt. % to 85 wt. %, from 85 wt. % to 99 wt. %, from 90 wt. % to 99 wt. %, from 93 wt. % to 99 wt. %, from 93 wt. % to 95 wt. %, or any subset thereof, of the inorganic solid electrolyte.

The solid electrolyte may comprise a polymeric solid electrolyte. In embodiments, the solid electrolyte may comprise a blend of an inorganic solid electrolyte and a polymeric solid electrolyte. In embodiments, the ratio of inorganic solid electrolyte to polymeric solid electrolyte may be from 1:1 to 99:1, from 1:1 to 9:1, from 1:1 to 8:1, from 1:1 to 7:1, from 1:1 to 6:1, from 1:1 to 5:1, from 1:1 to 4:1, from 1:1 to 3:1, from 1:1 to 2:1, from 2:1 to 99:1, from 3:1 to 99:1, from 4:1 to 99:1, from 5:1 to 99:1, from 6:1 to 99:1, from 7:1 to 99:1, from 8:1 to 99:1, from 9:1 to 99:1, from 95:1 to 99:1, or any subset thereof.

The filler may comprise an insulating material. In embodiments, the filler may have an electrical conductivity of less than 10⁻⁹ S/cm, such as less than 10⁻¹⁰ S/cm, or even less than 10⁻¹¹ S/cm. Without being limited by theory, it is believed that when the electrical conductivity of the filler is too high, the filler can create electrical connections between the anode and the cathode, thereby short circuiting within the battery.

The filler may comprise fibers. The fibers may have a generally cylindrical shape, a tubular shape (such as nanotubes), or any other elongated shape. The fibers may have an aspect ratio (L/D) of at least 100/1, such as at least 150/1, at least 200/1, at least 250/1, at least 500/1, at least 1000/1, at least 1500/1, at least 2000/1, or even at least 10,000/1. Without being limited by theory, it is believed that fibers with a relatively high aspect ratio may adhere to a relatively great amount of the solid electrolyte, thereby providing greater strength to the separator.

The fibers may have a length of from 10 nm to 1000 nm. In embodiments, the fibers may have a length of from 10 nm to 800 nm, from 10 nm to 600 nm, from 10 nm to 400 nm, from 10 nm to 200 nm, from 10 nm to 100 nm, from 10 nm to 50 nm, from 10 nm to 25 nm, from 25 nm to 1000 nm, from 50 nm to 1000 nm, from 75 nm to 1000 nm, from 100 nm to 1000 nm, from 200 nm to 1000 nm, from 400 nm to 1000 nm, from 600 nm to 1000 nm, from 800 nm to 1000 nm, or any subset thereof.

The fibers may comprise polymeric materials, glass materials, or ceramic materials. The polymeric materials may comprise polyaramid (PA), polyether ether ketone (PEEK), polyphenylene sulfide, polyethyleneimine, polysulfone, polyethersulfone, polyphenylsulfone, nylon PA 6, nylon PA 12, polyethylene terephthalate (PET), polyurethane (PU), polyethylene (PE), or polypropylene (PP). The glass materials may include fiberglass. The fiberglass may comprise at least 50 wt. % of silicon dioxide. The ceramic materials may comprise boron nitride, such as boron nitride nanotubes.

The fibers may be dispersed randomly in all three directions (x, y, and z directions). The filler may be in the form of individual fibers, rather than in the form of mat (such as a pre-woven or nonwoven mat).

The separator 106 may comprise from 0.1 wt. % to 10 wt. % of the filler. In embodiments, the separator 106 may comprise from 0.1 wt. % to 8 wt. %, from 0.1 wt. % to 6 wt. %, from 0.1 wt. % to 4 wt. %, from 0.1 wt. % to 2 wt. %, from 0.5 wt. % to 10 wt. %, from 1 wt. % to 10 wt. %, from 2 wt. % to 10 wt. %, from 4 wt. % to 10 wt. %, from 2 wt. % to 8 wt. %, from 4 wt. % to 6 wt. %, or any subset thereof of the filler. Without being limited by theory, it is believed that when the separator 106 comprises too little of the filler (such as less than 0.1 wt. % or less than 4 wt. %), the separator 106 will have diminished mechanical properties (such as being too brittle). It is further believed that when the separator 106 comprises too much of the filler (such as more than 10 wt. % or more than 6 wt. %) the separator 106 will lack sufficient ionic conductivity for proper function of the battery.

The separator 106 may comprise a binder. The binder may be a polymeric compound, such as an elastomer (also known as a “rubber”). The elastomer may comprise nitrile butadiene rubber, styrene-butadiene-styrene, or polytetrafluoroethylene (PTFE), or polyvinylidene fluoride (PVDF), or poly (methyl) methacrylate (PMMA), or poly (butyl acrylate).

The separator 106 may comprise from 0.1 wt. % to 10 wt. % of the binder. In embodiments, the separator 106 may comprise from 0.1 wt. % to 8 wt. %, from 0.1 wt. % to 6 wt. %, from 0.1 wt. % to 4 wt. %, from 1 wt. % to 10 wt. %, from 2 wt. % to 10 wt. %, from 2 wt. % to 4 wt. %, or any subset thereof of the binder. Without being limited by theory, it is believed that when the separator 106 comprises too little of the binder (such as less than 0.1 wt. % or less than 2 wt. %), the separator 106 will have diminished mechanical properties (such as being too brittle). It is further believed that when the separator 106 comprises too much of the binder (such as more than 10 wt. % or more than 4 wt. %) the separator 106 will lack sufficient ionic conductivity for proper function of the battery.

The separator 106 may comprise primarily the filler, the inorganic solid electrolyte, and optionally the binder. In embodiments, the separator 106 may comprise at least 75 wt. %, such as at least 80 wt. %, at least 85 wt. %, at least 90 wt. %, at least 95 wt. %, at least 98 wt. %, at least 99 wt. %, or even at least 99.9 wt. % of the total weight of the binder, the filler, and the solid electrolyte, on the basis of the total weight of the separator 106.

The separator 106 may have a thickness of less than 200 μm, such as less than 150 μm, less than 100 μm, less than 50 μm, less than 30 μm, from 10 to 200 μm, from 10 to 100 μm, from 10 to 50 μm, from 10 to 40 μm, from 10 to 30 μm, from 10 to 20 μm, or any subset thereof. Without being limited by theory, it is believed that when the separator 106 is too thick (such as greater than 200 μm or greater than 30 μm), the overall ionic resistance of the separator 106 will be too high for ideal battery function. It is further believed that when the separator 106 is too thin, the separator 106 may lack mechanical strength and either prevent assembly of the battery or cause the battery to short circuit.

The separator 106 may have an ionic conductivity of at least 10⁻⁵ S/cm, such as from 10⁻² S/cm to 10⁻⁵ S/cm, 10⁻² S/cm to 10⁻³ S/cm, 10⁻³ S/cm to 10⁻⁴ S/cm, 10⁻⁴ S/cm to 10⁻⁵ S/cm, or any combination of these ranges. Without being limited by theory, it is believed that if the ionic conductivity of the separator 106 is too low, battery efficiency will suffer. Ionic conductivity may be deconvoluted from overall conductivity using electrochemical impedance spectroscopy (EIS).

The separator 106 may have an electrical conductivity less than its ionic conductivity. In embodiments, the separator 106 may have an electrical conductivity of less than 1/10^{th} its ionic conductivity, less than 1/100^{th} its ionic conductivity, less than 1/1000^{th} its ionic conductivity, or even less than 1/10000^{th} its ionic conductivity. In embodiments, the separator 106 may have an electrical conductivity of less than 10⁻⁹ S/cm. Electrical conductivity may be deconvoluted from overall conductivity using electrochemical impedance spectroscopy (EIS) or chronoamperometry measurements.

The separator 106 may have an overall resistance of less than 10 ohm, such as less than 9 ohm, less than 8 ohm, or less than 7 ohm.

Embodiments of the present disclosure are further directed to processes for producing a separator. The process for producing a separator may comprise producing a filler by introducing polymeric fibers to an organic solvent comprising a base, thereby forming a polymeric dispersion; precipitating the polymeric dispersion, thereby forming a coagulated mass; purifying the coagulated mass, thereby producing the filler.

The base may be an organic base or an inorganic base (such as NaOH or KOH).

The organic solvent may comprise dimethyl sulfoxide (DMSO).

The organic solvent comprising the base may have a pH of at least 9. In embodiments, the organic solvent comprising the base may have a pH of at least 9, such as at least 10, at least 11, at least 12, at least 13, at least 14, from 9 to 14, from 10 to 14, from 11 to 14, from 12 to 14, from 13 to 14, or any subset thereof.

The polymeric fibers added to the organic solvent may comprise fibers of polyaramid (PA), polyether ether ketone (PEEK), polyphenylene sulfide, polyethyleneimine, polysulfone, polyethersulfone, polyphenylsulfone, nylon PA 6, nylon PA 12, polyethylene terephthalate (PET), polyurethane (PU), polyethylene (PE), or polypropylene (PP). In some embodiments, the polymeric fibers may comprise fibers of polyaramid.

The polymeric dispersion may be mixed (such as by stirring) for a dissolution time. The dissolution time may be at least 1 day, such as at least 2 days, at least 3 days, at least 4 days, at least 5 days, from 1 to 10 days, from 2 to 10 days, from 3 to 10 days, from 4 to 10 days, or any subset thereof.

Precipitating the polymeric dispersion may comprise introducing a polar compound to the polymeric dispersion. The polar compound may comprise water or an alcohol.

In alternate embodiments, the process may comprise mechanically milling (such as ball milling) a mixture of boron nitride and a functionalizing agent, thereby forming the filler. The functionalizing agent may comprise urea, NH₃, KOH, oleyalmine, or acetic acid. In embodiments, the functionalizing agent may comprise urea. The boron nitride may be in the form of hexagonal boron nitride. The mixture may comprise from a 1:10 to 1:100 ratio of boron nitride:functionalizing agent, such as a ratio of from 1:10 to 1:75, from 1:10 to 1:40, from 1:20 to 1:100, from 1:25 to 1:100, from 1:20 to 1:40, from 1:25 to 1:35, or any subset thereof.

The process for producing the separator may comprise combining a binder and an organic solvent; combining the filler and the organic solvent to produce a filler mixture; mixing or sonicating the filler mixture to produce a dispersed filler mixture; combining the dispersed filler mixture with a solid electrolyte powder to produce a solid electrolyte suspension; mixing the solid electrolyte suspension; casting the solid electrolyte suspension into a film; and removing solvent from the film, thereby forming the separator.

The solid electrolyte suspension may comprise at least 40 wt. %, such as at least 50 wt. %, at least 60 wt. %, at least 70 wt. %, at least 80 wt. %, at least 90 wt. %, from 40 wt. % to 90 wt. %, from 40 wt. % to 80 wt. %, from 40 wt. % to 70 wt. %, from 40 wt. % to 60 wt. %, from 40 wt. % to 50 wt. %, or any subset thereof of the organic solvent, on the basis of the total weight of the solid electrolyte suspension.

The organic solvent may comprise, for example, one or more of heptane, hexane, bromoform, tetrahydrofuran (THF), 1,4-dioxane, propylene carbonate, p-xylene, toluene, anisole, isobutyl isobutyrate, chloroform, or dibromomethane.

Mixing the solid electrolyte suspension may comprise mechanically milling the solid electrolyte suspension, such as ball milling the solid electrolyte suspension.

Casting the solid electrolyte suspension into a film may comprise doctor blade coating, bar coating, gravure coating, slot-die coating, or screen printing the solid electrolyte suspension to form a film.

Removing solvent from the film may comprise allowing the film to dry at room temperature or at elevated temperature (such as from 50° C. to 100° C., or from 50° C. to 70° C.) and at atmospheric pressure or at a reduced pressure (such as less than 14 pounds per square inch absolute (PSI), less than 10 PSI, or less than 5 PSI).

The Separator may be tested using one or more of the following methods. The conductivity may be tested using the following steps. The separators are punched into ½″ diameter films and pressed between metal pistons in a custom electrochemical test cell. The pistons are sealed with a dynamic O-ring seal to allow external compression to transfer to the sample. Electrochemical impedance spectroscopy is used on the assembled electrochemical cell to determine the ionic conductivity of the developed composites where a 10 mV amplitude is applied to an electrode for a range of frequencies, typically between 100,000 Hz-1 Hz.

The flexibility may be determined according to ASTM D4338-97(2021).

The following non-limiting examples are provided to further illustrate various embodiments of a solid-state battery separator.

Polymeric Fiber Preparation (KV) includes electrically insulating aramid nanofibers with an aspect ratio (L/D) of at least 100/1 were synthesized through a chemical process. First, KOH was dissolved in dimethyl sulfoxide (DMSO) to form a solution with concentration 3 g/L. Bulk polyaramid fibers were added to the solution and the mixture was stirred for 5 days until the polyaramid was dissolved into the KOH-DMSO solution, forming a red dispersion. After 5 days, water was added to the red dispersion while stirring, coagulating the nanofibers. The coagulated mass was purified through multiple rounds of centrifugation and solvent washing with several solvents starting with water, ethanol, acetone, thereby producing the filler.

Boron Nitride Filler Preparation (BN) includes boron nitride fillers with an aspect ratio L/D of at least 100/1 were synthesized by mechanical ball milling a mixture of hexagonal boron nitride powder with urea powder with a boron nitride:urea ratio of 1:30.

Glass Fillers (G) include glass fillers with an aspect ratio L/D of at least 100/1 were provided by the Johns Manville Company.

### Separator Fabrication for Electrochemical Testing CE-A. CE-B. EX-2, and EX-3:

The separators were fabricated through a slurry-based process. First, a hydrogenated nitrile butadiene rubber (HNBR) binder was dissolved in dimethyl sulfoxide (DMSO) solvent. The fillers were added to the dissolved binder solution and dispersed using magnetic stirring and sonication (at least one hour of each). Next, the Li₆PS₅Cl solid electrolyte powder was added to the binder-filler-solvent dispersion and mixed. To ensure fine particle size and dispersion, the mixture was added to a planetary ball mill and allowed to mix for 3 hours at 300 RPM. The mixture was then removed from the milling media and cast onto silicone coated Mylar (biaxially oriented polyethylene terephthalate (PET)) or polytetrafluoroethylene (PTFE) sheets) substrate using a tape casting technique and allowed to dry. The films were then heated to 60° C. to ensure full removal of the solvent from the films. The dried films were then peeled off from the carrier substrate and integrated into the battery as a free-standing film or laminated onto a neighboring electrode and removed from the carrier film.

Compositions of the tested materials are shown in Table 1. The boron nitride fillers prepared herein are listed as BN. G refers to nanofiber glass fillers. KV refers to the polymeric fillers prepared herein.

TABLE 1

| | CE-A | CE-B | EX-1 | EX-2 | EX-3 |
|---|---|---|---|---|---|
| Li₆PS₅Cl (wt. %) | 100 | 97 | 92 | 92 | 92 |
| Binder (wt. %) | 0 | 3 | 3 | 3 | 3 |
| BN (wt. %) | 0 | 0 | 5 | 0 | 0 |
| G (wt. %) | 0 | 0 | 0 | 5 | 0 |
| KV (wt. %) | 0 | 0 | 0 | 0 | 5 |

### Separator Electrochemical Testing

The separators were punched into ½″ diameter films and pressed between metal pistons in a custom electrochemical test cell. The pistons were sealed with a dynamic O-ring seal to allow external compression to transfer to the sample. Electrochemical impedance spectroscopy was used on the assembled electrochemical cell to determine the ionic conductivity of the developed composites where a 10 mV amplitude was applied to an electrode for a range of frequencies, typically between 100,000 Hz-1 Hz. Other film properties were determined as described in the Test Methods. Film properties are shown in Table 2.

TABLE 2

| | CE-A | CE-B | EX-1 | EX-2 | EX-3 |
|---|---|---|---|---|---|
| Thickness | 200 μm | 25 μm | 25 μm | 25 μm | 25 μm |
| Ionic Conductivity (S/cm) | 1.36e⁻³ | 2.83e⁻⁴ | 6.00e⁻⁵ | 2.20e⁻⁴ | 2.60e⁻⁴ |
| Resistance (Ohm) | 11 | 7 | 32.8 | 8.9 | 7.6 |

As can be seen from Table 2, the embodiments of the present examples EX-2 and EX-3 are able to achieve significantly lower resistances than the comparative example CE-A (just the base solid electrolyte), despite their reduced ionic conductivity. This resistance improvement is believed to be due to their reduced thickness, which is enabled by their improved mechanical properties.

The prepared separators retained their structure with the addition of the fillers and required lower amounts of binder when using the filler+binder+solid electrolyte combinations, relative to binder+solid electrolyte only films. Further experimental results shown that a separator comprising 1 wt. % binder and 1 wt. % solid electrolyte could be released from the substrate without visible damage. In contrast, experimental results showed that a separator comprising less than or equal to 3 wt. % of binder could not be released from the substrate without visible damage.

### Separator Mechanical Testing:

The separators were fabricated through the slurry-based method. First, a triblock styrene-butylene-ethylene-styrene binder was dissolved in toluene. In EX-4, the same polymeric filler (KV) prepared herein was added to the dissolved binder solution and dispersed using magnetic stirring and sonication (at least one hour of each). Next, for both CE-C and EX-4, the Li₆PS₅Cl solid electrolyte powder was added to the binder-filler-solvent dispersion to form a mixture comprising 35 wt. % solid electrolyte, from 1-10 wt. % binder, and, where present, from 1-3 wt. % of the polymeric filler. To ensure fine particle size and dispersion, the mixture was added to a planetary ball mill and allowed to mix for 3 hours at 300 RPM. The mixture was then removed from the milling media and cast onto silicone coated Mylar (biaxially oriented polyethylene terephthalate (PET)) or polytetrafluoroethylene (PTFE) sheets) substrate using a tape casting technique and allowed to dry at room temperature. Compositions of the tested materials are shown in Table 3.

TABLE 3

| | CE-C | EX-4 |
|---|---|---|
| Li₆PS₅Cl (wt. %) | 97 | 94-96 |
| Binder (wt. %) | 3 | 3 |
| KV (wt. %) | 0 | 1-3 |

CE-C and EX-4 were then subjected to flexibility testing according to ASTM D4338-97. CE-C showed signs of damage at 4% strain while EX-4 did not show signs of damage until 6% strain. Thus, the inclusion of the polymeric filler (KV) produced at least a 50% increase in the amount of strain which the separator can withstand before being damaged.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A separator comprising a filler and an inorganic solid electrolyte, wherein:
the filler comprises fibers with an aspect ratio (L/D) of at least 100/1; and
the separator has a thickness of less than 200 μm.

2. The separator of claim 1, further comprising a binder.

3. The separator of claim 2, wherein the binder comprises an elastomer.

4. The separator of claim 3, wherein the elastomer comprises nitrile butadiene rubber, styrene-butadiene-styrene, polytetrafluoroethylene (PTFE), polyvinylidene fluoride (PVDF), or polymethyl methacrylate, or poly(butyl acrylate).

5. The separator of claim 1, wherein the filler has an electrical conductivity of less than 10⁻⁹ S/cm.

6. The separator of claim 1, wherein the filler comprises a polymeric material, a glass material, or a ceramic material.

7. The separator of claim 1, the filler comprises polyaramid, polyether ether ketone, polyphenylene sulfide, polyethyleneimine, polysulfone, polyethersulfone, polyphenylsulfone, nylon PA 6, PA 12, polyethylene terephthalate, polyurethane, polyethylene, polypropylene; boron nitride, or fiberglass.

8. The separator of claim 1, wherein the filler comprises boron nitride nanotubes.

9. The separator of claim 1, wherein the filler comprises fibers with a length of from 10 nm to 1000 nm.

10. The separator of claim 1, wherein the inorganic solid electrolyte comprises oxides, sulfides, phosphates, or halides of lithium.

11. The separator of claim 1, wherein the solid electrolyte is selected from Li₃PS₄, Li₆PS₅Cl, Li₁₀GeP₂S₁₂; Li₃InC₆, Li₃YCl₆, and Li₃YBr₆.

12. The separator of claim 1, wherein the separator has a thickness of from 10 μm to 200 μm.

13. The separator of claim 1, wherein the separator has an ionic conductivity of from 10⁻² S/cm to 10⁻⁵ S/cm.

14. The separator of claim 1, wherein the separator comprises from 0.1 wt. % to 10 wt. % of the filler.

15. The separator of claim 2, wherein the separator comprises from 0.1 wt. % to 10 wt. % of the binder.

16. The separator of claim 1, wherein:
the separator comprises from 2 wt. % to 5 wt. % of a binder;
the separator comprises from 4 wt. % to 6 wt. % of the filler;
the filler comprises polyaramid fibers;
the filler has an electrical conductivity of less than 10⁻⁹ S/cm;
the filler comprises fibers with a length of from 10 nm to 1000 nm;
the separator has a thickness of from 10 μm to 30 μm; and
the separator has an ionic conductivity of from 10⁻³ S/cm to 10⁻⁵ S/cm; and
the solid electrolyte is selected from Li₃PS₄, Li₆PS₅Cl, Li₁₀GeP₂S₁₂; Li₃InC₆, Li₃YCl₆, and Li₃YBr₆; and
the separator comprises at least 99 wt. % of the total weight of the binder, the filler, and the solid electrolyte, on the basis of the total weight of the separator.

17. A solid state battery comprising: an anode, a cathode, and the separator of claim 1 disposed between the anode and the cathode.

18. A process for producing a separator, the process comprising:
combining a binder and an organic solvent;
combining a filler and the organic solvent to produce a filler mixture;
mixing or sonicating the filler mixture to produce a dispersed filler mixture;
combining the dispersed filler mixture with a solid electrolyte powder to produce a solid electrolyte suspension;
mixing the solid electrolyte suspension;
casting the solid electrolyte suspension into a film; and
removing solvent from the film, thereby producing the separator.

19. The process of claim 18 further comprising:
introducing polymeric fibers to a second organic solvent comprising a base, thereby forming a polymeric dispersion;
precipitating the polymeric dispersion, thereby forming a coagulated mass;
purifying the coagulated mass, thereby producing the filler.

20. The process of claim 19 further comprising mechanically milling a mixture of boron nitride and urea, thereby forming the filler.
